(19) United States
(12) Patent Application Publication
(10) Pub. No.: US 2004/0186802 A1
(43) Pub. Date: Sep. 23, 2004

(54) Systems and methods for automatically processing customer discounts and generating marketing data

(76) Inventor: Renee Castelluzzo, Northlake, IL (US)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/390,204

(22) Filed: Mar. 17, 2003

(51) Int. Cl. G06F 17/60

(52) U.S. Cl. 705/35; 705/42

(57) ABSTRACT

A store or other entity distributes checks that designate a value for a consumer discount to be received toward the purchase of goods and/or services. The document or instrument within which the discount is indicated is actually a check that may be processed in accordance with the normal processing and routing of any other check that a business may receive in exchange for goods and/or services. Advantageously, separate processing above and beyond that which is normally provided for normal check processing is not required. The check is drawn for a nominal amount and is usually substantially less than the value of the discount that is received by the consumer. Banks will still process the check for the nominal check value notwithstanding the fact that the actual processing fees incurred may be equivalent to the value of the check. The check may be made payable to the business entity and the bank statement may be useful in determining consumer feedback information.

### BACKGROUND OF THE INVENTION

1. Field of the Invention

The present invention relates generally to the field of systems and methods for using and processing customer coupon or discount documents and for generating marketing data based on consumer usage of the devices. More specifically, the present invention is directed to systems and methods for processing customer value checks which provide consumers with discounts on products and/or services in a more efficient and economical manner. Data relating to usage of the products can be easily used for generating marketing information.

2. Description of the Related Art

There are currently available a wide-variety of customer discount devices which businesses may use in order to increase sales and also generate marketing information related to the consumers of their products. The primary technique that has been used for many years is the conventional coupon that is transmitted or delivered to consumers and which is then used by individual consumers. The coupons typically provide the consumer with a reduction in the price of goods and/or services. This typically involves presentation of the coupon to the store by the consumer either prior to or during a transaction. The consumer receives a reduction in the cost of the goods or services in exchange for the coupon.

The traditional coupon is then processed by the entity that receives the coupon. The subsequent processing of the coupon provides the ability to acquire some information relating to the consumer from the redemption of the coupon. For example, the consumer of goods and/or services may be identified in a general sense based on the correlation between the redeemed coupon and a class of individuals to which the coupons were originally transmitted or that otherwise are likely to have received the coupon. Those skilled in the art will appreciate that other types of information may also be derived from the redemption processing information.

More recently, electronic coupon systems have been made available wherein individuals are able to sign up through the internet to receive electronic coupons that may be printed at an individual's location. The individual then can receive coupon data via electronic mail and the individual is able to print out the coupon for subsequent use at a store that is willing to accept the coupon. One of the significant shortcomings of these more conventional coupon techniques is that the store which receives the coupon must usually internally process the coupon in order to receive compensation from the manufacturer of products upon which the discount has been provided. Many stores are willing to accept manufacturer coupons for providing the designated discount on the product which is for sale at the store. This compensation will typically be provided by the manufacturer direct to the retail operation. Individual retail stores may also provide their own coupons direct to consumers.

In retail stores, such as, for example, food stores or other retail chains, the coupons must be manually sorted in order to ensure that the coupons are routed to the appropriate processing facility. This is necessary in order to be certain that the appropriate compensation will be provided to the retail operation. The sorting process is a significant undertaking and is both time consuming and an undesired expense that is now necessarily incurred by the retail store.

One advantage to some of the newer techniques for generating coupon information is that the coupons themselves may be coded with unique identifier information so that the store or other entity that has provided and accepted the coupon can utilize feedback from the information that is derived during processing of the coupon. This additional information may be used in order to generate additional marketing information that can be utilized by various entities in subsequent marketing of the same goods and/or services as well as similar products and services. Nevertheless, there remains a significant shortcoming in that the additional subsequent task of processing the coupon is still required.

More recently, in order to avoid some of the shortcomings and deficiencies associated with more conventional coupon processing techniques, it has been proposed that businesses generate a check that may be transmitted to individual consumers of the business for use as a discount against a purchase of goods or services from the business. This technique has proven useful in generating more specific feedback information for the business entity. More specifically, these checks are typically transmitted directly to individual consumers who have been designated as the recipient of the discount.

In utilizing this approach, the store itself receives the discount check from the consumer in conjunction with the purchase of goods or services. The store or business that provides the discount is both the payor and the payee in the transaction and the check typically designates that the individual who has received a check will receive a specified discount on purchases of goods and/or services. For example, one such check may indicate that the check is good for $15 with purchases of $50 or more. The value check may indicate that only a particular individual or household is entitled to receive the specified discount.

One advantage of this known prior approach to providing consumers with discounts which can be useful in generating customer feedback information is that separate processing by the store is not required and that the check can be simply processed along with other checks that are received by the store from consumers in exchange for goods and/or services. Furthermore, these marketing campaigns are useful in generating very specific information relating to the purchasing habits of specific consumers rather than those that fall into more general categories.

However, one very significant shortcoming of this prior approach is that when such a promotion is utilized, banks typically require that the store or other entity employing the marketing campaign have sufficient funds set aside with the bank in the account on which the checks are to be drawn for the full amount of all the checks that are distributed and made available to consumers as a discount against goods and/or services. This is true even though it is well recognized that only a fraction of the total number of checks that have been transmitted will be redeemed by the consumers that have received them. For example, if a store employs a marketing campaign in which 100,000 consumers each receive a $10 discount, the store would be required by the bank to deposit $1 million in the account upon which the checks are drawn. However, even a 20 percent redemption rate would be substantial. Most marketing campaigns do not even have that high of a rate of redemption.

For large or even mid-sized businesses, when a $5.00 or $10.00 discount is provided, the funds that are required to be set aside for the discount promotion at the bank can be very substantial. Often these deposit requirements can run into several millions or even tens of millions of dollars in cash value. As a result, most companies are unwilling to participate in these types of promotional arrangements due to the substantial cash deposit requirements. Furthermore, even those entities that are willing participate to in these types of marketing campaigns will significantly limit their participation in order to reduce the overall amount of cash which must be made available within the specified account.

As a result, there remains a very significant need in the art for new and improved systems and methods for providing consumers with discounts and for generating consumer feedback information which do not suffer from the shortcomings and deficiencies of existing conventional coupon techniques and/or discount check techniques.

There also remains a need in the art for consumer discount techniques which do not require the use of separate processing for the consumer discount. The inventor of the technology set forth in the present application has overcome the deficiencies and shortcomings of these existing marketing devices.

### SUMMARY OF THE INVENTION

The present invention overcomes the deficiencies and shortcomings of the prior art by providing novel systems and methods for providing customer discounts while also providing the ability to generate feedback information. In accordance with a first preferred exemplary embodiment of the present invention, a store or other entity distributes directly to consumers personalized value checks that designate a value for the consumer discount to be received within the store toward the purchase of goods and/or services. Those skilled in the art will also appreciate that manufacturers could also use this technique.

The document within which the discount is indicated is actually a check that may be processed in accordance with the normal processing and routing of any other check that a business may receive in exchange for goods and/or services. Thus, advantageously, separate processing above and beyond that which is normally provided for normal monetary exchanges is not required.

In accordance with the preferred exemplary embodiment of the present invention, the check is drawn for a nominal amount and is usually substantially less than the value of the discount that is received by the consumer. More specifically, in accordance with the preferred exemplary embodiment, the check value is preferably only one cent in actual value. In contrast, the discount provided to the consumer will typically be greater than 5 dollars, for example. Banks will still process the check for the nominal check value notwithstanding the fact that the actual processing fees incurred may be equivalent to the value of the check. The check may be made payable to the business entity and the bank statement may be useful in determining consumer feedback information. For example, a particular retail operation can readily use bank statement information in order to correlate redemption of the discount to specific individuals or households that have received the promotion.

More specifically, in accordance with a first preferred exemplary embodiment of the present invention, a direct marketing entity or other business may use a mailing list of individuals who are designated as recipients of the dual value discount checks. This mailing list is then used to generate the hard copy print out of the checks. The checks may be distributed via the mail or through other direct marketing efforts and the consumer who has received the check is then able to present the check to a store or other merchant in order to receive the advertised premium on the check. At the end of the day, the store or other merchant who has received the check deposits the value check in the same manner as with any other checks received from consumers.

Thereafter, the check is processed in similar fashion to all other checks that the business has received. The bank processes the check and makes the appropriate transfer of funds. As noted above, this is typically only in the range of one cent per transaction and the deposit requirements are substantially reduced. Significantly, the amount of money that the entity providing the discount is required to have on deposit at the bank is now much less than the value of the discount provided to the consumers. As a result, many business operations that were previously unwilling to participate in these types of marketing campaigns due to financial concerns are now willing to use this marketing tool.

Bank statement or similar information identifying the checks that have been deposited can be used in order to generate very precise consumer feedback information. This is a very substantial benefit to most retail operations. Moreover, manufacturers and other business operations can use similar techniques in order to provide consumers with incentives that may also be utilized in order to generate increased sales activity.

Yet another significant benefit is that through adopting this marketing tool, retail operations can ultimately eliminate their internal coupon processing operations. This is yet another very significant advantage over the previously existing techniques for providing consumers with discounts on goods and/or services and for automatically generating consumer redemption information pertaining to coupon discounts and the like.

In an alternate preferred exemplary embodiment, a check tracking process utilizes the banking system encoding data to capture response information to a direct-mail campaign. In accordance with this exemplary embodiment, a unique ID number is printed on a direct-mail solicitation and may also be included on an outgoing mailing list. The unique ID number is preferably specifically correlated with a particular household or business address on an outgoing mailing list.

The unique ID number can then be used when it is captured during bank processing to confirm that the recipient has responded to the offer. The offer may be printed on a value check instrument which is preferably laid out according to existing banking regulations and will also preferably comply with bank processing specifications. Current bank processing regulations require that the account number, routing numbers and a specific check number or unique ID be printed in an OCR font of the check encoding area. Bank processing regulations also require that a payee, check amount as well as the name of the originating bank where the account is held be identified on the instrument.

In accordance with this preferred exemplary embodiment, the discount instrument or value check is arranged such that the upper two-thirds of the check are provided for advertising a discount in the form of a dollar amount or any other offer that is desired. For example, it is contemplated that monetary discounts as well as complementary products or other items may be designated. For example, it is contemplated that the financial instrument can be used to designate buy one get one free awards as well as specific dollar amounts designated as a discount.

In accordance with the preferred exemplary embodiment, approximately the lower one-third of the document or instrument is arranged for bank processing data as described above.

### BRIEF DESCRIPTION OF THE DRAWINGS

FIG. 1 illustrates a first exemplary embodiment of the present invention;

FIG. 2 is a flow diagram illustration of steps associated with the processing of the discount product illustrated in FIG. 1;

FIG. 3 is a flow diagram illustration of additional steps associated with the processing of the discount product illustrated in FIG. 1.

### DETAILED DESCRIPTION OF THE PRESENTLY PREFERRED EMBODIMENTS

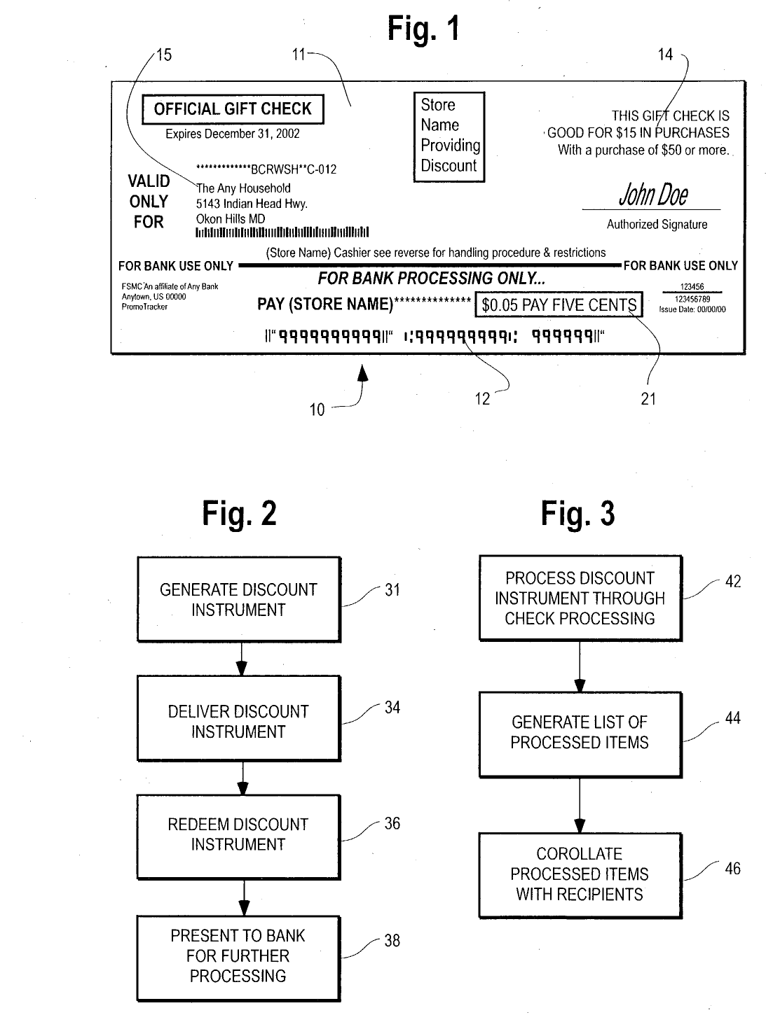

FIG. 1 illustrates a first preferred exemplary embodiment of the present invention which is shown generally at 10. As shown in the illustration of FIG. 1 and described in more detail below, the lower portion of the document or instrument 11 provides routing information 12 to be used by a bank for processing the instrument as any other check would typically be processed. The bank routing and processing information 12 preferably includes such things as, for example, account number, routing numbers, as well as a check number or unique identifier. The OCR characters for the routing and processing information are preferably applied to the instrument 11 with magnetic toner using (high-speed continuous form) laser printers.

The upper portion of the document or instrument at portion 14 preferably identifies a discount that is to be received toward the purchase of goods and/or services. In an alternate embodiment, this portion of the document could identify a premium that is to be received by the consumer such as, for example, a free item. In accordance with a first preferred exemplary embodiment of the present invention, a store or other entity distributes directly to consumers personalized value checks 11 that designate a value 14 for the consumer discount to be received within the store toward the purchase of goods and/or services. As shown in exemplary illustration, the designated discount is $15 toward the purchase of $50 of products. Those skilled in the art will also appreciate that manufacturers could also use this technique.

Another portion of the instrument 15 also preferably identifies an individual or household which is entitled to receive the specified premium or discount. Those skilled in the art will appreciate that this designation is unnecessary. Other information such as, for example, expiration dates and store or product names and/or other marketing information may also be included. The marketing and other discount related information is preferably located in the upper portion of the check instrument as shown in FIG. 1.

Significantly, the financial instrument or check also includes a payment amount that is designated to be preferably substantially less than the value of the discount. For example, as shown in FIG. 1, portion 21 identifies a payment amount of only five cents. Typically, as shown in the illustration of FIG. 1, the store or other entity that is to receive the payment will be the same as that owner of the bank account upon which the check is to be drawn. Actually, it is not even necessary that money actually be transferred between two distinct entities.

The document 11 within which the discount is indicated is actually a check that may be processed in accordance with the normal processing and routing of any other check that a business may receive in exchange for goods and/or services. Thus, advantageously, separate processing above and beyond that which is normally provided for normal monetary exchanges is not required. When all coupons are handled in this manner, stores can eliminate their internal coupon processing obligations.

In accordance with the preferred exemplary embodiment of the present invention, the check is drawn for a nominal amount that is usually substantially less than the value of the discount that is received by the consumer. More specifically, in accordance with the preferred exemplary embodiment, the check value is preferably only one cent in actual value. In contrast, the discount provided to the consumer will typically be greater than 5 dollars, for example. Banks will still process the check for the nominal check value notwithstanding the fact that the actual processing fees incurred may be equivalent to the value of the check. The check may be made payable to the business entity and the bank statement may be useful in determining consumer feedback information. For example, a particular retail operation can readily use bank statement or other check processing information in order to correlate redemption of the discount or premium to specific individuals or households that have received the promotion.

More specifically, in accordance with a first preferred exemplary embodiment of the present invention, a direct marketing entity or other business may use a mailing list of individuals who are designated as recipients of the dual value discount checks. This mailing list is then used to generate the hard copy print out of the checks. The checks may be distributed via the mail or through other direct marketing efforts and the consumer who has received the check is then able to present the check to a store or other merchant in order to receive the advertised premium on the check. At the end of the day, the store or other merchant who has received the check deposits the value check in the same manner as with any other checks received from consumers.

Thereafter, the check is processed in similar fashion to all other checks that the business has received. The bank processes the check and makes the appropriate transfer of funds. As noted above, this is typically only in the range of one to five cents. Significantly, the amount of money that the entity providing the discount is required to have on deposit at the bank is substantially reduced. As a result, many business operations that were previously unwilling to participate in these types of marketing campaigns due to financial concerns are now willing to use this marketing tool.

Bank statement or similar information identifying the checks that have been deposited can be used in order to generate very precise consumer feedback information. This is a very substantial benefit to most retail operations. Moreover, manufacturers and other business operations can use similar techniques in order to provide consumers with incentives that may also be utilized in order to generate additional sales activity.

FIG. 2 is a flow diagram illustration which identifies the steps associated with generating and utilizing discount instruments in accordance with the present invention. As shown in FIG. 2, in a first step 31, check or discount instruments are generated through printing. This step preferably includes printing of the requisite bank routing information including a unique identifier for the instrument. Additionally, the discount value for using the instrument as well as the check value are printed.

Thereafter, the individual discount checks are preferably transmitted or delivered to individual consumers in a step 34. Preferably, the individual consumers or households that receive the discount checks may be correlated with the unique identifier mentioned above. This may be useful in subsequent processing for the purpose of generating additional marketing information based on redemption data.

In a subsequent step 36, the consumer redeems the discount instrument at a retail location. As noted above, in exchange for presenting the coupon or value check, the consumer typically receives a discount in the costs of goods and/or services. Alternatively, a premium may be provided such as a free product.

Thereafter, in step 38, the coupon or value check is presented to a bank for processing as any other check would be presented that has been received from a consumer. The bank then processes the check in its normal course of business.

FIG. 3 illustrates steps associated with generating additional marketing data based on consumer redemption information or usage of the coupon or discount instruments. In a first step 42, the bank processes the check or discount instrument as any other check that is received by the bank. Those skilled in the art will appreciate the initial bank which receives such a check may not be the bank that actually makes payment on the device. In any event, ultimately the designated payor transfers the required funds as specified in the instrument.

In step 44, bank statement or other processing information is utilized in order to generate a list of those individual checks or discount instruments that have been processed. This is preferably accomplished through utilizing the unique identifier information that is preferably included on each of the value checks or discount instruments.

In step 46, the redemption information identifying the individual unique identifier that is associated with the checks or discount instruments that have been processed are correlated with the individuals or households that have received the value checks or discount instruments. Those skilled in the art will appreciate that it is not necessary to provide a direct correlation between individuals and households. However, this is the preferred approach that will provide more specific information that may be used in subsequent marketing campaigns.

In an alternative approach, unique identifiers may be utilized on individual value checks or instruments. However, numeric range data or other categories of identification information may be correlated with classes of individuals or groups which receive the discount instruments or value checks. Thereafter, redemption or usage information can be thereafter correlated in similar fashion. The techniques described herein thus provide a simple and convenient mechanism for automatically acquiring marketing data.

Yet another significant benefit is that through adopting this marketing technique, retail operations can ultimately eliminate their internal coupon processing operations. This is yet another very significant advantage over the previously existing techniques for providing consumers with discounts on goods and/or services and for automatically generating consumer redemption information pertaining to coupon discounts and the like.

In an alternate preferred exemplary embodiment, a response tracking process utilizes the banking system encoding data to capture response information through utilizing a direct-mail campaign. In accordance with this exemplary embodiment, a unique ID number is printed on a direct-mail solicitation and may also be included on an outgoing mailing list. The unique ID number is preferably specifically correlated with a particular household or business address on an outgoing mailing list.

The unique ID number can then be used when it is captured during bank processing to confirm that the recipient has responded to the offer. The offer may be printed on a value check instrument which is preferably laid out according to existing banking regulations and will also preferably comply with bank processing specifications. Current bank processing regulations require that the account number, routing numbers and a specific check number or unique ID be printed in an OCR font of the check encoding area. Bank processing regulations also require that a payee, check amount as well as the name of the originating bank where the account is held be identified on the instrument.

In accordance with this preferred exemplary embodiment, the discount instrument or value check is arranged such that the upper two-thirds of the check are provided for advertising a discount in the form of a dollar amount or any other offer that is desired. For example, it is contemplated that monetary discounts as well as complementary products may be designated. For example, it is contemplated that the financial instrument can be used to designate buy one get one free awards as well as specific dollar amounts designated as a discount.

In accordance with the preferred exemplary embodiment, approximately the lower one-third of the document or instrument is arranged for bank processing data as described above.

It should be recognized that the foregoing description relates to exemplary embodiments of the present invention. These described embodiments should be considered illustrative only and those skilled in the art will appreciate that the invention is not limited to the specific examples set forth herein. Accordingly, the following claims should be given their broadest possible construction in light of the exemplary embodiments of the invention described herein.

I claim:

1. A discount instrument comprising:
a first portion designating bank routing and/or processing information;
a second portion identifying a discount or premium to be received in exchange for presenting the discount instrument; and
a third portion identifying payment information designating an amount to be transferred from a payor to a payee through the processing of the instrument, wherein the amount to be exchanged is less than the value of the designated discount or premium.

2. The discount instrument of claim 1, wherein the discount instrument is a check.

3. The discount instrument of claim 1, wherein the payor is the same as the payee.

4. The discount instrument of claim 1, wherein the processing information includes a unique identifier.

5. The discount instrument of claim 1, further comprising expiration date information.

6. The discount instrument of claim 1, wherein the identified discount is a 5 dollar reduction in the costs of goods or services.

7. The discount instrument of claim 1, wherein the identified discount is a 10 dollar reduction in the costs of goods or services.

8. The discount instrument of claim 4, wherein the unique identifier may be correlated with a recipient of the instrument.

9. A method of using a discount instrument comprising the steps of:
presenting to an entity an instrument having a first portion designating bank routing and/or processing information, a second portion identifying a discount or premium to be received in exchange for presenting the discount instrument; and a third portion identifying payment information designating an amount to be transferred from a payor to a payee through the processing of the discount instrument, wherein the amount to be exchanged is less than the value of the designated discount or premium; and
thereafter presenting the discount instrument to a bank for processing as a check.

10. The method of using the discount instrument of claim 9, wherein the payor is the same as the payee.

11. The method of using the discount instrument of claim 9, wherein the processing information includes a unique identifier.

12. The method of using the discount instrument of claim 9, wherein the discount instrument further comprises expiration date information.

13. The method of using the discount instrument of claim 9, wherein the identified discount is a 5 dollar reduction in the costs of goods or services.

14. The method of using the discount instrument of claim 9, wherein the identified discount is a 10 dollar reduction in the costs of goods or services.

15. The method of using the discount instrument of claim 11, further comprising a step of correlating the unique identifier with a recipient of the discount instrument.

16. The method of using the discount instrument of claim 11, further comprising a step of correlating the unique identifier with a class of people that have received the instrument.

17. The method of using the discount instrument of claim 11, further comprising a step of generating to the unique I.D. (identification), from the store when the instrument was processed.
